(19) United States
(12) Patent Application Publication
(10) Pub. No.: US 2025/0231441 A1
(43) Pub. Date: Jul. 17, 2025

(54) DISPLAY DEVICE

(71) Applicant: Japan Display Inc., Tokyo (JP)

(72) Inventor: Kentaro Okuyama, Tokyo (JP)

(73) Assignee: Japan Display Inc., Tokyo (JP)

(21) Appl. No.: 19/013,069

(22) Filed: Jan. 8, 2025

(30) Foreign Application Priority Data
Jan. 12, 2024 (JP) 2024-003111

(51) Int. Cl. G02F 1/13357; G02F 1/1334

(52) U.S. Cl. CPC G02F 1/133615; G02F 1/1334; G02F 2201/56

(57) ABSTRACT

According to one embodiment, a display device includes an irregular shaped first substrate, an irregular shaped second substrate, a polymer-dispersed liquid crystal layer, an irregular shaped cover member having a first side surface and opposing the second substrate, a plurality of light emitting elements which irradiate light on the first side surface, and a control unit which adjusts intensity of light irradiated from each of the light emitting elements. The first side surface functions as a light-entering surface to which light emitted from each light emitting element enters. The adjustment unit adjusts the intensity of light emitted from each light emitting element according to the distance from the input surface to the counter-light-entering surface.

### CROSS-REFERENCE TO RELATED APPLICATIONS

This application is based upon and claims the benefit of priority from Japanese Patent Application No. 2024-003111, filed Jan. 12, 2024, the entire contents of which are incorporated herein by reference.

### FIELD

Embodiments described herein relate generally to a display device.

### BACKGROUND

Various display devices using polymer-dispersed liquid crystals that can switch between a scattering state that scatters incident light and a transparent state that transmits incident light have been proposed. In some display devices using polymer-dispersed liquid crystals, the edge-light method, in which a light emitting module is arranged at an edge of the display panel, is used. Such display devices have high transmittance, and therefore they are expected to be used in various fields, such as in-vehicle applications, and in recent years, display devices with shapes that differ from rectangles (irregular shapes) have been attracting attention.

In the edge-light-mode display devices, the light emitting modules arranged at the edges of the display panel are controlled to light up in such a way that the same intensity of light is irradiated over the entire surface. However, in display devices with an irregular shape, if such lighting control is performed, non-uniformity in the brightness of the display panel may occur. For this reason, in display devices with an irregular shape, there is a desire for the realization of new technology that can make the brightness of the display panel uniform.

### BRIEF DESCRIPTION OF THE DRAWINGS

FIG. 1 is a plan view showing an example of a display device according to one embodiment.

FIG. 2 is a diagram illustrating an example of display operation of the display device according to the same embodiment.

FIG. 3 is a diagram illustrating the lighting control of light emitting elements in a rectangular display device.

FIG. 4 is a diagram illustrating the lighting control of light emitting elements in the display device according to the embodiment.

FIG. 5 is a diagram illustrating the lighting control of the light emitting elements in the display device according to the embodiment.

FIG. 6 is a diagram illustrating a method for adjusting the intensity of light emitted from the light emitting elements in the display device according to the same embodiment.

FIG. 7 is a diagram illustrating the method for adjusting the intensity of light emitted from the light emitting elements in the display device according to the same embodiment.

FIG. 8 is a diagram illustrating the method for adjusting the intensity of light emitted from the light emitting elements in the display device according to the same embodiment.

FIG. 9 is a plan view showing an example of the display device according to the embodiment.

FIG. 10 is a diagram illustrating the lighting control of the light emitting elements in the display device according to the same embodiment.

FIG. 11 is a plan view showing an example of a display device according to the first modified example.

FIG. 12 is a cross-sectional view showing an example of a display panel according to the same modified example.

FIG. 13 is a cross-sectional view showing an example of the display panel according to the same modified example.

FIG. 14 is a diagram showing an example of a display panel according to the second modified example.

FIG. 15 is a diagram showing an example of the display panel according to the same modified example.

### DETAILED DESCRIPTION

In general, according to one embodiment, a display device comprises an irregular shaped first substrate, an irregular shaped second substrate opposing the first substrate, a polymer-dispersed liquid crystal layer disposed between the first substrate and the second substrate, an irregular shaped cover member having a first side surface and opposing the second substrate, a plurality of light emitting elements which irradiate light on the first side surface, and a control unit which adjusts intensity of light irradiated from each of the light emitting elements, and the first side surface functions as a light-entering surface to which light emitted from each light emitting element enters, and the adjustment unit adjusts the intensity of light emitted from each light emitting element according to the distance from the input surface to the counter-light-entering surface.

Embodiments will be described hereinafter with reference to the accompanying drawings.

Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

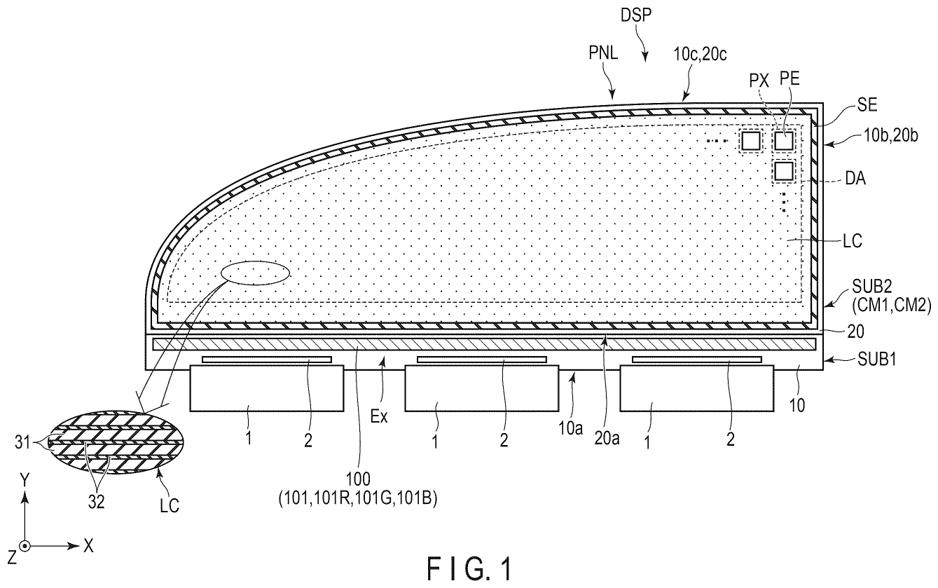

FIG. 1 is a plan view showing an example of a display device DSP of this embodiment. For example, a first direction X, a second direction Y, and a third direction Z are orthogonal to each other, but they may intersect at an angle other than 90 degrees. The first direction X and the second direction Y correspond to directions parallel to a main surface of the substrate that constitutes the display device DSP, and the third direction Z corresponds to the thickness direction of the display device DSP. In this embodiment, viewing an X-Y plane defined by the first direction X and the second direction Y is referred to as plan view.

The display device DSP comprises a display panel PNL, a wiring substrate 1, an IC chip 2, and a light emitting module 100.

As shown in FIG. 1, the display panel PNL of this embodiment is formed into a shape (irregular shape) that is different from a rectangle. The display panel PNL is a so-called transparent display, and comprises a first substrate SUB1 (array substrate), a second substrate SUB2 (counter-substrate), a liquid crystal layer LC (polymer-dispersed liquid crystal layer) containing polymer-dispersed liquid crystals, a seal SE, a first cover member CM1 arranged under the first substrate SUB1, and a second cover member CM2 arranged on the second substrate SUB2. Note that here such a configuration that the display panel PNL comprises the first cover member CM1 is shown, but the display panel PNL may not have the first cover member CM1.

The first substrate SUB1, the second substrate SUB2, the first cover member CM1, and the second cover member CM2 are formed into irregular shapes of similar type, for example, with curved portions.

The first substrate SUB1 and the second substrate SUB2 overlap each other in plan view. The area where the first substrate SUB1 and the second substrate SUB2 overlap includes a display area DA for displaying images. The display area DA is formed into an irregular shape as in the case of the first substrate SUB1 and the second substrate SUB2.

The display area DA comprises a plurality of pixels PX. The plurality of pixels PX are arranged in accordance with the shape of the display area DA. These pixels PX are indicated by dotted lines in the figure. Further, each of the pixels PX comprises a pixel electrode PE, which is indicated by a solid square in the figure.

The first substrate SUB1 comprises a first transparent substrate 10, and the second substrate SUB2 comprises a second transparent substrate 20. The first transparent substrate 10 has a side surface 10a along the first direction X, a side surface 10b along the second direction Y, and a curved side surface 10c. The second transparent substrate 20 has a side surface 20a along the first direction X, a side surface 20b along the second direction Y, and a curved side surface 20c.

In the example illustrated in FIG. 1, the side surface 10b and the side surface 20b and the side surface 10c and the side surface 20c overlap each other respectively in plan view, but they do not necessarily have to overlap. The side surface 20a does not overlap the side surface 10a, and is located between the side surface 10a and the display area DA. The first substrate SUB1 includes an extending portion Ex between the side surface 10a and the side surface 20a. In other words, the extending portion Ex corresponds to the part of the first substrate SUB1 that extends in the second direction Y from the part that overlaps the second substrate SUB2, and does not overlap the second substrate SUB2.

The wiring substrate 1 and the IC chip 2 are mounted on the extending portion Ex. The wiring substrate 1 is, for example, a flexible printed circuit board that can be bent. The IC chip 2, for example, contains a display driver that outputs signals necessary for image display and a controller (adjustment means) that can adjust the intensity of light emitted from the light emitting module 100. Note that the term “intensity of light” used in this specification may be read interchangeably as the “amount of light”.

The IC chip 2 may be mounted on the wiring substrate 1. In the example illustrated in FIG. 1, a plurality of circuit boards 1 are mounted along the first direction X with respect to the display panel PNL, but a single circuit board 1 extending in the first direction X may be mounted. Further, a plurality of IC chips 2 are mounted along the first direction X with respect to the display panel PNL, but a single IC chip 2 extending along the first direction X may be mounted.

The light emitting module 100 is disposed so as to overlap the extending portion Ex and oppose the side surface 20a of the second transparent substrate 20 in plan view. Note here that for the sake of illustration, the light emitting module 100 is shown here as being arranged so as to oppose the side surface 20a of the second transparent substrate 20, but it is preferable that the light emitting module 100 should be arranged so as to oppose the side surface (first side surface) of the second cover member CM2. Further, note here that the light emitting module 100 may be arranged, as shown in FIG. 1, to oppose the side surface 20a of the second transparent substrate 20, or it may be arranged to oppose the side surface 20a of the second transparent substrate 20 and the side surface of the second cover member CM2. Moreover, the light emitting module 100 may be arranged on the rear surface of the extending portion Ex so as to oppose the side surface of the first cover member CM1.

Between the light emitting module 100 and the light-entering surface (in the case of FIG. 1, the side surface 20a of the second transparent substrate 20) into which light emitted from the light emitting module 100 enters, an optical system is provided, which refracts the light emitted from the light emitting module 100 so as to be perpendicular to the light-entering surface, that is, for example, a lens, (in other words, an optical system which refracts the light emitted from the light emitting module 100 so as to be parallel to the main surface of the first substrate SUB1). Alternatively, the light-entering surface described above may be processed into a lens shape.

The light emitting module 100 comprises a number of light emitting elements 101. Each of the light emitting elements 101 contains, for example, a light emitting element 101R that emits red light, a light emitting element 101G that emits green light, and a light emitting element 101B that emits blue light, for color display. For the light emitting elements 101R, 101G, and 101B, for example, light emitting diodes (LEDs) can be used, but the type of the elements is not limited to that of this example, but laser diodes (LDs), for example, may as well be used. As will be described in more detail later, in this embodiment, the display device DSP is driven using a field sequential mode in which, during a single frame period, the video components corresponding to red, green, and blue are written in a time-shared manner, and the light emitting elements of the colors corresponding to the written video components are lit in a time-shared manner.

Note that each of the light emitting elements 101 may as well be a light emitting element that emits white light for black-and-white display. Alternatively, each of the light emitting elements 101 may be a light emitting element that emits one of the colors, for example, red, green, or blue, for single-color display.

The seal SE adheres the first substrate SUB1 and the second substrate SUB2 together. The seal SE is formed into an irregular frame shape similar to that of the display area DA, so as to surround the liquid crystal layer LC between the first substrate SUB1 and the second substrate SUB2.

As shown schematically in an enlarged manner in FIG. 1, the liquid crystal layer LC contains polymers 31 and liquid crystal molecules 32. For example, the polymers 31 are liquid crystal polymers. The polymers 31 are formed into a strip shape extending along the first direction X and are arranged along the second direction Y. The liquid crystal molecules 32 are dispersed in the gaps of the polymers 31 and aligned so that their longitudinal axes are set along the first direction X. Each of the polymers 31 and the liquid crystal molecules 32 has optical anisotropy or refractive index anisotropy. The responsivity of the polymers 31 to electric field is lower than the responsivity of the liquid crystal molecules 32 to electric field.

For example, the alignment direction of the polymers 31 does not substantially change regardless of the presence or absence of an electric field. On the other hand, the alignment direction of the liquid crystal molecules 32 changes in response to the electric field when a high voltage higher than or equal to the threshold value is being applied to the liquid crystal layer LC. When no voltage is being applied to the liquid crystal layer LC (the initial alignment state), the optical axes of the polymers 31 and the liquid crystal molecules 32 are substantially parallel to each other, and light that enters the liquid crystal layer LC almost completely passes through the liquid crystal layer LC (transparent state). When a voltage is being applied to the liquid crystal layer LC, the alignment direction of the liquid crystal molecules 32 changes, and the optical axes of the polymers 31 and the liquid crystal molecules 32 intersect each other. Therefore, the light that enters the liquid crystal layer LC is scattered within the liquid crystal layer LC (scattered state).

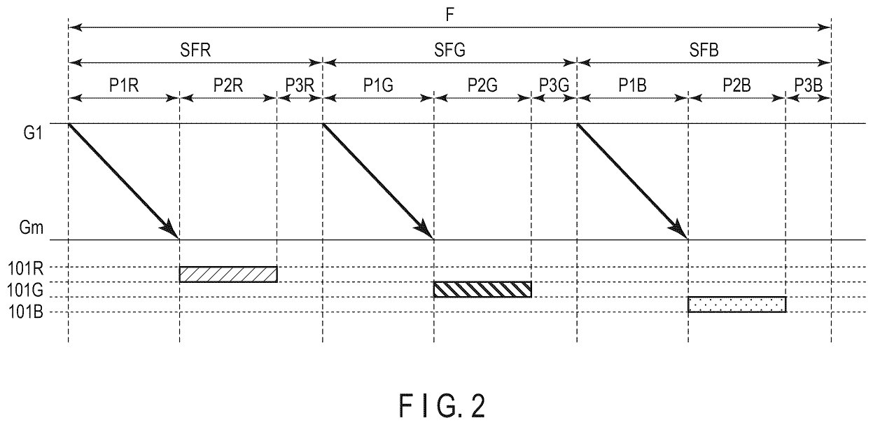

FIG. 2 is a diagram illustrating an example of the display operation of the display device DSP in this embodiment.

In the display operation of the display device DSP, one frame period F includes a red subframe period SFR in which an image component corresponding to red is written and the red light emitting element 101R is made to emit light, a green subframe period SFG in which an image component corresponding to green is written and the green light emitting element 101G is made to emit light, and a blue subframe period SFB in which an image component corresponding to blue is written and the blue light emitting element 101B is made to emit light. Further, each of the subframe periods SFG, SFB, and SFG includes a write period P1 for writing the image component of the corresponding color to a respective pixel PX, a light emission period P2 for making the light emitting element 101 of the corresponding color to emit light, and a reset period P3 for resetting the image component written to a respective pixel PX.

First, the red subframe period SFG will be described. When the write period P1R included in the red subframe period SFR is started, scanning signals are supplied to respective scanning lines, sequentially from the scanning line G1 closest to the counter-light-entering surface, which is located on an opposite side to the light-entering surface into which light emitted from the light emitting element 101 (light emitting module 100) enters, to a scanning line Gm closest to the light-entering surface, and the image components corresponding to the red color are written sequentially to the respective pixels PX, starting from the one arranged on a side of the counter?-light-entering surface towards the pixel PX arranged on the light-entering surface.

When the write period P1R is finished and the emission period P2R is started, the red light emitting element 101R emits light. The light emitted from the red light emitting element 101R passes through the light-entering surface and enters the display area DA. Accordingly, in the display area DA, red images corresponding to the red image components written to the respective pixels PX during the write period P1R are displayed.

When the light emission period P2R is finished, the red light emitting elements 101R are turned off, and the reset period P3R is started, scanning signals are simultaneously supplied to the scanning lines G1 to Gm, and a voltage equivalent to the so-called common voltage is applied to each of the respective pixels PX. In this manner, the red image components written to the respective pixels PX are reset.

When the reset period P3R is finished, the red subframe period SFR is finished as well.

Next, the green subframe period SFG will be explained. When the red subframe period SFG is finished and the write period PIG included in the green subframe period SFG is started, the scanning signals are supplied to the respective scanning lines, sequentially from the scanning line G1 on the counter-light-entering surface side towards the scanning line Gm on the light-entering surface, and the image components corresponding to green are sequentially written to the respective pixels, from the pixel PX on the counter-light-entering surface side towards the pixel PX on the light-entering surface side.

When the write period PIG is finished and the emission period P2G is started, the green light emitting element 101G emits light. The light emitted from the green light emitting element 101G passes through the light-entering surface and enters the display area DA. Accordingly, green images corresponding to the green image components written to the respective pixels PX during the write period PIG are displayed in the display area DA.

When the light emission period P2G is finished, the green light emitting element 101G is turned off and the reset period P3G is started, scanning signals are supplied simultaneously to the scanning lines G1 to Gm, and a voltage equivalent to the common voltage is applied to the respective pixels PX. In this manner, the green image components written to these pixels PX are reset.

When the reset period P3G is finished, the green subframe period SFG is finished as well.

Furthermore, the blue subframe period SFB will be described. When the green subframe period SFG is finished and the write period P1B included in the blue subframe period SFB is started, scanning signals are supplied to scanning lines, sequentially from the scanning line G1 on the counter-light-entering surface side to the scanning line Gm on the light-entering surface side, and the image components corresponding to the blue color are written to the pixels, sequentially from the pixel PX on the counter-light-entering surface towards the pixel PX on the light-entering surface side.

When the write period P1B is finished and the emission period P2B is started, the blue light emitting element 101B emits light. The light emitted from the blue light emitting element 101B passes through the light-entering surface and enters the display area DA. Accordingly, on the display area DA, blue images corresponding to the blue image components written to the respective pixels PX during the write period P1B are displayed.

When the light emission period P2B is finished, the blue light emitting element 101B is turned off and the reset period P3B is started, the scanning signals are supplied simultaneously to the scanning lines G1 to Gm, and a voltage equivalent to the common voltage is applied to the respective pixels PX. In this manner, the blue image components written to these pixels PX are reset.

When the reset period P3B is finished, the blue subframe period SFB is finished as well, and the one frame period F is finished.

Note here that the display operation shown in FIG. 2 is explained as an example of the display operation of the display device DSP of this embodiment, but the operation is not limited to this. For example, the display device DSP may display images on the display area DA by a display operation that differs from that illustrated in FIG. 2.

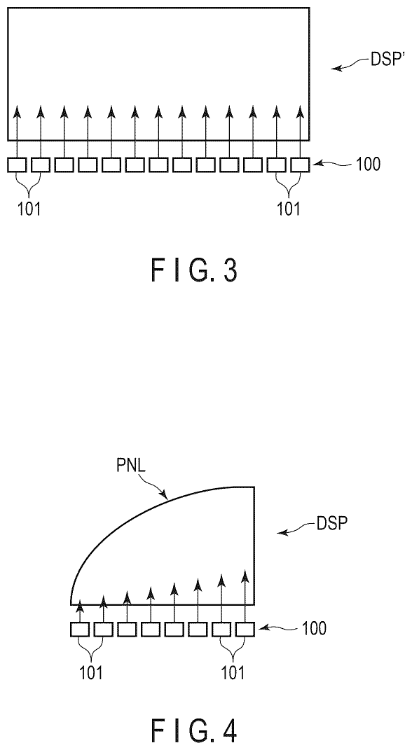

Incidentally, as shown in FIG. 3, in a general rectangular display device DSP' (display panel), the lighting conditions of light emitting elements 101 that constitute the light emitting module 100 are all the same as each other, and the light emitting elements 101 are lit up to emit light of the same intensity. Note that in FIG. 3, the length of the arrow extending from each light emitting element 101 indicates the intensity of the light emitted from the respective light emitting element 101.

In the case of the display device DSP (display panel PNL) having an irregular shape according to this embodiment, when, similarly, the light emitting elements 101 are lit up to emit light of the same intensity, the following drawback arises.

That is, in general, the intensity of light emitted from a light emitting element 101 tends to decrease as it proceeds through the display panel. Therefore, in a display device such as the display device DSP of this embodiment, which has a display panel with an irregular shape, in which the distance from the light-entering surface to the counter-light-entering surface is not constant, when the light emitting elements 101 are controlled to emit light of the same intensity, the luminance may become higher in the areas where the distance from the light-entering surface to the counter-light-entering surface is shorter, whereas the luminance may become lower in the areas where the distance from the light-entering surface to the counter-light-entering surface is longer. In other words, non-uniformity in the brightness of the display panel may occur.

In order to avoid this, according to the display device DSP of this embodiment, as shown in FIG. 4, the intensity of the light emitted from each light emitting element 101 is adjusted according to the distance from the light-entering surface to the counter-light-entering surface by controlling the lighting of the light emitting elements 101. More specifically, as shown in FIG. 4, the lighting of the light emitting elements 101 are controlled such that the intensity of the light emitted from the light emitting elements 101 corresponding to the areas where the distance from the light-entering surface to the counter-light-entering surface is shorter is lowered, and the intensity of the light emitted from the light emitting elements 101 corresponding to the areas where the distance from the light-entering surface to the counter-light-entering surface is longer is increased. In other words, the display device DSP controls the lighting of the light emitting elements 101 such that the intensity of the light emitted from the light emitting elements 101 corresponding to the areas where the distance from the light-entering surface to the counter-light-entering surface is longer is made higher than the intensity of the light emitted from the light emitting elements 101 corresponding to the areas where the distance from the light-entering surface to the counter-light-entering surface is shorter. In this manner, it is possible to suppress the occurrence of non-uniformity in the brightness of the display panel PNL and to make the brightness of the display panel PNL uniform.

Note that FIG. 4 illustrates an example case where the light emitting elements 101 are controlled to light up in such a way that the intensity of the light irradiated from the respective light emitting element 101 is gradually increased from the left side of the figure to the right side of the figure, but the control operation is not limited to this. For example, the light emitting elements 101 may be divided into a plurality of blocks (groups) based on the distance from the light-entering surface to the counter-light-entering surface, and the light emitting elements 101 are controlled such that the light intensity emitted from the respective light emitting elements 101 are adjusted in units of blocks.

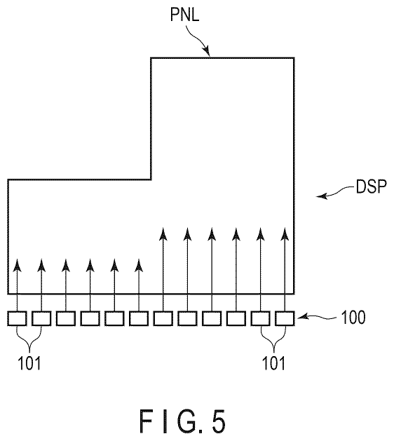

Further, in FIG. 4, it is assumed that the display device DSP comprises a display panel PNL of an irregular shape having a curved portion, and the configuration can be applied as well to the case where, for example, the display device DSP includes a display panel PNL of an irregular shape, which includes two rectangular portions of different sizes, as shown in FIG. 5. In this case as well, the lighting operations for the light emitting elements 101 are controlled such that the intensity of the light emitted from those of the light emitting elements 101 which correspond to the areas where the distance from the light-entering surface to the counter-light-entering surface is shorter is lowered (in other words, the intensity of the light emitted from the light emitting elements 101 on the left side of the figure is lowered), whereas the intensity of the light emitted from those of the light emitting elements 101 which correspond to the areas where the distance from the light-entering surface to the counter-light-entering surface is longer is increased (in other words, the intensity of the light emitted from the light emitting elements 101 on the right side of the figure is increased). The above-provided operation can be applied as well to the case where the display device DSP comprises a display panel PNL of some other shape.

The intensity of the light emitted from each light emitting element 101 is determined and adjusted by, for example, controlling the lighting of the light emitting elements 101 to emit light of the same intensity, and then feeding back the brightness distribution of the display panel PNL obtained as the results thereof, before shipping the products. Alternatively, the intensity of the light emitted from each light emitting element 101 may as well be determined and adjusted by feeding back the amount of light measured by a light sensor arranged on the counter-light-entering surface side. In the latter case, it is possible to dynamically determine and adjust the intensity of the light emitted from each light emitting element 101 even after the shipment of the products. Note that the light sensor may as well be disposed on the light-entering surface side after a reflective member (for example, reflective tape) provided on the counter-light-entering surface side to reflect light back to the light-entering surface side.

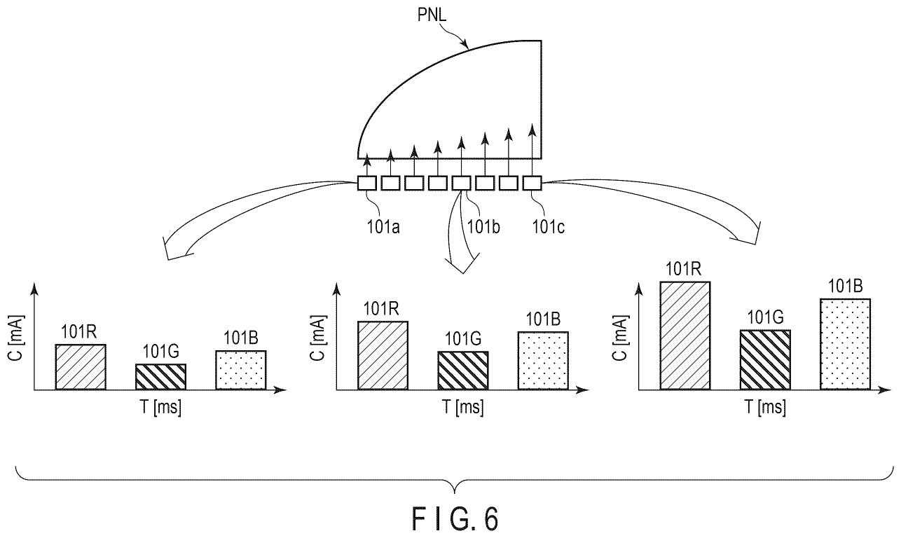

FIGS. 6 to 8 are diagrams illustrating methods for adjusting the intensity of the light emitted from the light emitting elements 101. Note that in FIGS. 6 to 8, it is assumed that the intensity of light of color is higher in the order of red light emitting element 101R, blue light emitting element 101B, and green light emitting element 101G, but the intensity of light of color may not necessarily be higher in the order described above. The intensity of light of each color is determined based on, for example, the white balance of the display panel PNL.

FIG. 6 is a diagram illustrating an amplitude modulation mode, which is one of the methods for adjusting the intensity of light emitted from the light emitting elements 101.

As shown in FIG. 6, in the method of the amplitude modulation mode, a time T during which current is allowed to flow through each light emitting element 101 (in other words, the time during which each light emitting element 101 is emitting light) is kept constant, and the value of the current C allowed to flow through those of the light emitting elements 101 which correspond to the areas where the distance from the light-entering surface to the counter-light-entering surface is shorter, is lowered, whereas the value of the current C allowed to flow through those of the light emitting elements 101 which correspond to the areas where the distance from the light-entering surface to the counter-light-entering surface is longer, is increased. In FIG. 6, such an example case is illustrated that the value of the current C allowed to flow through light emitting elements 101a which correspond to the areas where the distance from the light-entering surface to the counter-light-entering surface is short, is reduced, the value of the current C allowed to flow through light emitting elements 101b which correspond to the areas where the distance from the light-entering surface to the counter-light-entering surface is medium, is increased to be higher as compared to the value of the current C allowed to flow through the light emitting elements 101a, and the value of the current C allowed to flow through light emitting elements 101c which correspond to the areas where the distance from the light-entering surface to the counter-light-entering surface is longer, is increased to be higher as compared to the value of the current C allowed to flow through the light emitting elements 101b. Note that, in this case, it is assumed that the intensity of light of color is higher in the order of red, blue, and green, and therefore the values of the currents C allowed to flow through the light emitting elements 101R, 101G, and 101B of the respective colors of the light emitting elements 101a, 101b, and 101c are those as shown in FIG. 6. That is, the value of the current C allowed to flow through the red light emitting element 101R is the highest, the value of the current C allowed to flow through the blue light emitting element 101B is the second highest, and the value of the current C allowed to flow through the green light emitting element 101G is the lowest.

According to the amplitude modulation method described above, the intensity of light emitted from light emitting elements 101 corresponding to the areas where the distance from the light-entering surface to the counter-light-entering surface is shorter can be lowered, and the intensity of light emitted from light emitting elements 101 corresponding to the areas where the distance from the light-entering surface to the counter-light-entering surface is longer can be increased, and therefore the occurrence of non-uniformity in the brightness of the display panel PNL can be suppressed, thereby making it possible to make the brightness of the display panel PNL uniform.

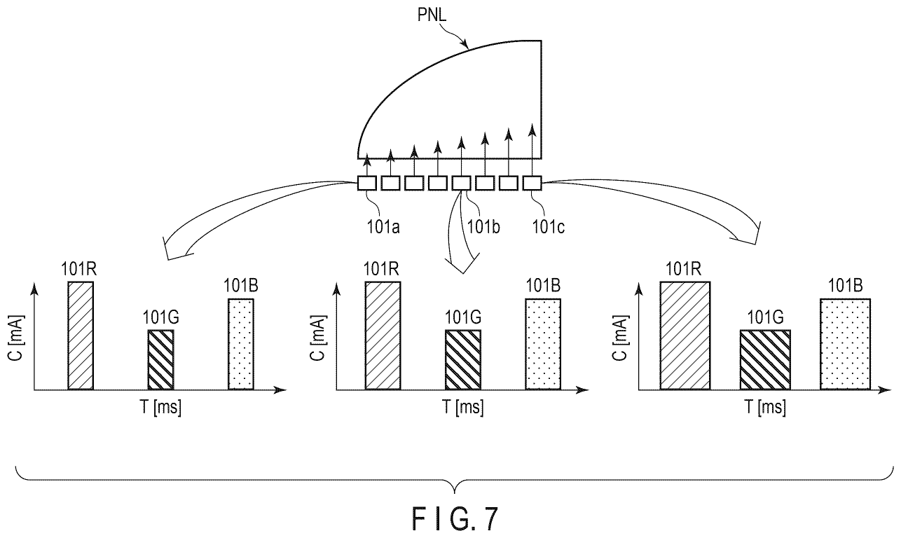

FIG. 7 is a diagram explaining the time modulation method, which is one of the methods of adjusting the intensity of the light emitted from the light emitting elements 101.

As shown in FIG. 7, according to this time modulation method, the value of the current C allowed flow through each light emitting element 101 is set to a constant for each color, and then the value of the time T during which the current is allowed to flow through the light emitting elements 101 corresponding to the areas where the distance from the light-entering surface to the counter-light-entering surface is shorter is reduced, and the value of the time T during which the is allowed to flow through the light emitting elements 101 corresponding to the areas where the distance from the light-entering surface to the counter-light-entering surface is longer is increased. In FIG. 7, such an example case is shown that the time T for which the current is allowed to flow through the light emitting element 101a, which corresponds to the areas where the distance from the light-entering surface to the counter-light-entering surface is short, is reduced, and the time T for which the current is allowed to flow through light emitting element 101b, which corresponds to the areas where the distance from the light-entering surface to the counter-light-entering surface is medium, is increased to be longer as compared to the time T for which the current is allowed to flow through the light emitting element 101a, and the time T for which the current is allowed to flow through the light emitting element 101c, which corresponds to the areas where the distance from the light-entering surface to the counter-light-entering surface is long, is increased to be longer as compared to the time T for which the current is allowed to flow through the light emitting element 101b. Note that in this case, it is assumed that the intensity of light of the colors is higher in the order of red, blue, and green, and therefore the values of the currents C allowed to flow through the light emitting elements 101R, 101G, and 101B of the respective colors of the light emitting elements 101a, 101b, and 101c are those as shown in FIG. 7. That is, the value of the current C allowed to flow through the red light emitting element 101R is the highest, the value of the current C allowed to flow through the blue light emitting element 101B is the second highest, and the value of the current C allowed to flow through the green light emitting element 101G is the lowest.

According to the time modulation method described above, the intensity of the light emitted from the light emitting elements 101 corresponding to the areas where the distance from the light-entering surface to the counter-light-entering surface is shorter can be lowered, and the intensity of the light emitted from the light emitting elements 101 corresponding to the areas where the distance from the light-entering surface to the counter-light-entering surface is longer can be increased as in the case of the amplitude modulation method shown in FIG. 6. Therefore, it is possible to suppress the occurrence of non-uniformity in the brightness of the display panel PNL and thus to make the brightness of the display panel PNL uniform.

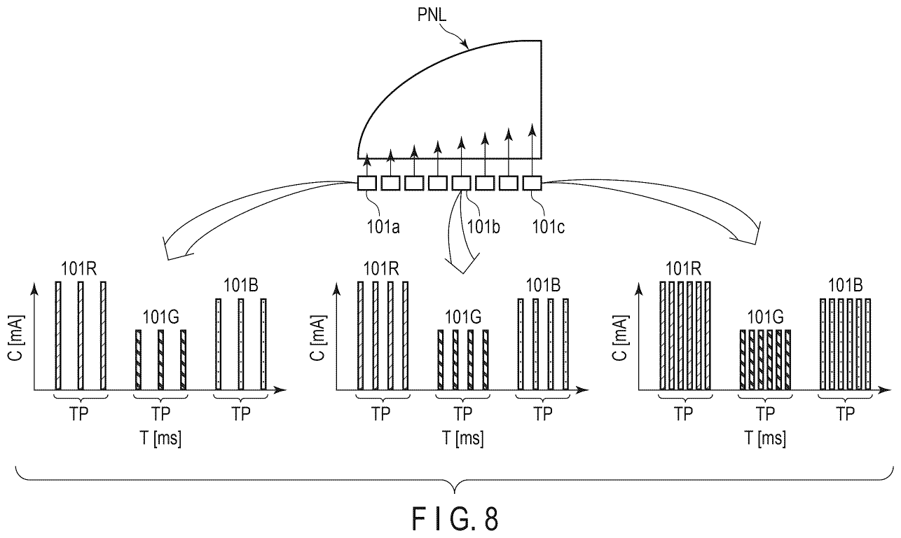

FIG. 8 is a diagram illustrating a pulse width modulation (PWM) method, which is one of the methods of adjusting the intensity of the light emitted from the light emitting elements 101.

As shown in FIG. 8, according to the PWM modulation method, the value of the current C allowed flow through the light emitting elements 101 is set to a constant for each color, and then the value of the time Tp during which the light emitting elements 101 corresponding to the areas where the distance from the light-entering surface to the counter-light-entering surface is shorter are on, is reduced, whereas the value of the time Tp during which the light emitting elements 101 corresponding to the areas where the distance from the light-entering surface to the counter-light-entering surface is longer are on, is increased. In FIG. 8, such an example case is shown that the value of the time Tp for which the light emitting element 101a, corresponding to the area where the distance from the light-entering surface to the counter-light-entering surface is short is on, is reduced, whereas the value of the time Tp for which the light emitting element 101b, corresponding to the area where the distance from the light-entering surface to the counter-light-entering surface is medium is on is increased to be greater as compared to the value of the time Tp for which the light emitting element 101a is on, and the value of the time Tp for which light emitting element 101c, corresponding to the area where the distance from the light-entering surface to the counter-light-entering surface is longer is on is increased to be greater as compared to the value of the time Tp for which light emitting element 101b is on. Note that in this case, it is assumed that the intensity of light of the colors is higher in the order of red, blue, and green, and therefore the values of the currents C allowed to flow through the light emitting elements 101R, 101G, and 101B of the respective colors of the light emitting elements 101a, 101b, and 101c are those as shown in FIG. 8. That is, the value of the current C allowed to flow through the red light emitting element 101R is the highest, the value of the current C allowed to flow through the blue light emitting element 101B is the second highest, and the value of the current C allowed to flow through the green light emitting element 101G is the lowest.

According to the PWM modulation method described above, the intensity of the light emitted from the light emitting elements 101 corresponding to the areas where the distance from the light-entering surface to the counter-light-entering surface is shorter can be lowered, and the intensity of the light emitted from the light emitting elements 101 corresponding to the areas where the distance from the light-entering surface to the counter-light-entering surface is longer can be increased as in the case of the amplitude modulation method shown in FIG. 6 and the time modulation method shown in FIG. 7. Therefore, it is possible to suppress the occurrence of non-uniformity in the brightness of the display panel PNL and thus to make the brightness of the display panel PNL uniform.

So far, the amplitude modulation method, the time modulation method, and the PWM modulation method are described as methods for adjusting the intensity of light irradiated from the light emitting elements 101, but the intensity of light irradiated from the light emitting elements 101 may as well be adjusted by a method set up by combining any of these methods.

Further, the methods of adjusting the intensity of the light emitted from each light emitting element 101 are described so far. But the following measures can as well be taken. That is, for example, in the areas where the distance from the light-entering surface to the counter-light-entering surface is shorter, the light emitting elements 101 are arranged sparsely, whereas in the areas where the distance from the light-entering surface to the counter-light-entering surface is longer, the light emitting elements 101 are arranged densely. With this configuration, even when the intensities of light emitted from the light emitting elements 101 are even, it is still possible to suppress the non-uniformity in the brightness of the display panel PNL and to make the brightness of the display panel PNL uniform. Alternatively, in the areas where the distance from the light-entering surface to the counter-light-entering surface is shorter, a less number of light emitting elements 101 are lit, whereas in the areas where the distance from the light-entering surface to the counter-light-entering surface is longer, a greater number of light emitting elements 101 are lit. With this configuration as well, even when the intensities of light emitted from the light emitting elements 101 are even, it is still possible to suppress the non-uniformity in the brightness of the display panel PNL and to make the brightness of the display panel PNL uniform.

As explained above, according to the display device DSP of this embodiment, the lighting of each respective light emitting element 101 is controlled such as to adjust the intensity of the light irradiated from the respective light emitting element 101 according to the distance from the light-entering surface to the counter-light-entering surface. Thereby, the occurrence of non-uniformity in the brightness of the display panel PNL can be suppressed and the brightness of the display panel PNL can be made uniform.

However, the intensity of the light emitted from the light emitting elements 101 tends to decrease as it progresses through the display panel PNL. Therefore, even if the intensity of the light emitted from the light emitting element 101 corresponding to the area where the distance from the light-entering surface to the counter-light-entering surface is longer is increased higher than the intensity of the light emitted from the light emitting element 101 corresponding to the areas where the distance from the light-entering surface to the counter-light-entering surface is shorter by the above-described lighting control, there is still a possibility that the luminance on the counter-light-entering surface side in the areas where the distance from the light-entering surface to the counter-light-entering surface is long will be slightly lower than the luminance of other parts (possibility of insufficient luminance).

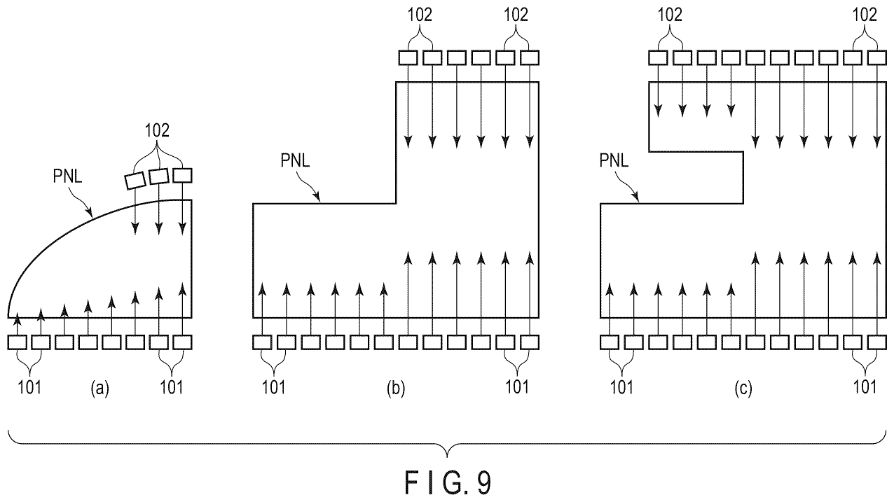

In such cases, for example, as shown in FIG. 9, part (a) to (c), auxiliary light emitting elements 102 can be provided on the counter-light-entering surface side corresponding to the areas where the luminance is insufficient. With this configuration, it is possible to eliminate the insufficiency of luminance occurring on the counter-light-entering surface side and to make the brightness of the display panel PNL uniform.

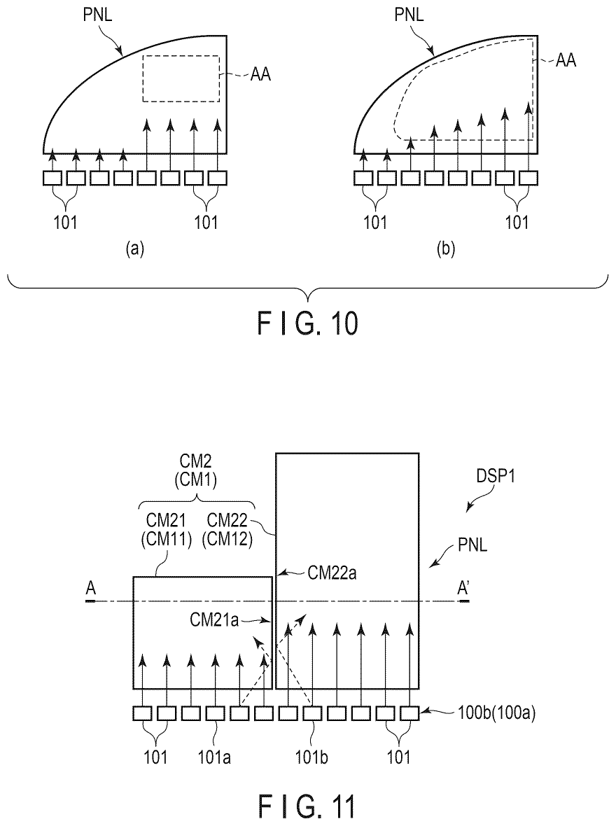

This embodiment is described in connection with the lighting control that adjusts the intensity of the light irradiated from each light emitting element 101 according to the distance from the light-entering surface to the counter-light-entering surface as the lighting control of each light emitting element 101 when an image is displayed over the entire display area DA. But, the lighting control may as well be applied to the case where an image is displayed only in a part of the display area DA, in which case, for example, the intensity of light emitted by light emitting elements 101 corresponding to an area AA, which is the part of the display area, is adjusted to be higher than the intensity of light emitted from light emitting elements 101 corresponding to the other parts of the area where no images are displayed, as shown in FIG. 10(a) by the lighting control. Here, note that FIG. 10, part (a) illustrates the case where the area AA, which is the part of the display area, where the image is displayed is rectangular. But, for example, as shown in FIG. 10(b), when the partial area AA, which is the part of the display area, where the image is displayed has an irregular shape, the lighting of the light emitting elements 101 may as well be controlled in such a way that the intensity of the light irradiated from the light emitting elements 101 corresponding to the partial area AA is higher than the intensity of the light irradiated from the light emitting element 101 corresponding to the other areas where no image is displayed, and further the intensity of the light irradiated from the light emitting elements 101 corresponding to the partial area AA where the distance from an end portion on the light-entering surface side to an end portion on the counter-light-entering surface side is long is set to be higher than the intensity of the light irradiated from the light emitting elements 101 corresponding to the area where the distance from the end portion on the light-entering surface side to the end portion on the counter-light-entering surface side is shorter.

Now, modified examples will be described.

### First Modified Example

First, the first modified example will be explained. A display device DSP1 of the first modified example is different in configuration from the above-provided embodiment in that the device comprises a light emitting module 100a disposed to oppose a side surface of the first cover member CM1 and a light emitting module 100b disposed to oppose a side surface of the second cover member CM2. Further, the display device DSP1 of the first modified example is different from the configuration of the above-provided embodiment in that the first cover member CM1 and the second cover member CM2 are each divided into a plurality of parts. In the following descriptions, mainly, parts that differ from those of the configuration of the above-provided embodiment will be explained, and the explanation of parts similar to those of the configuration of the above-provided embodiment will be omitted.

FIG. 11 is a plan view showing an example of the display device DSP1 according to the first modified example. In FIG. 11, of the elements which constitute the display device DSP1, only the light emitting module 100b (light emitting element 101) disposed to oppose the side surface of the second cover member CM2 and the two divided second cover members CM21 and CM22 are shown. Although not shown in FIG. 11, underneath the light emitting module 100b, further, the light emitting module 100a is disposed and underneath the second cover members CM21 and CM22, further, two divided first cover members CM11 and CM12 are disposed.

According to the configuration shown in FIG. 11, the linear progression properties of the light irradiated from each light emitting element 101 can be improved.

Generally, the light emitted from each light emitting element 101 is diffusing light, and therefore part of the light emitted from the light emitting elements 101 corresponding to the areas where the distance from the light-entering surface to the counter-light-entering surface is shorter progresses towards the areas where the distance from the light-entering surface to the counter-light-entering surface is longer, and part of the light emitted from the light emitting elements 101 corresponding to the areas where the distance from the light-entering surface to the counter-light-entering surface is longer progresses towards the areas where the distance from the light-entering surface to the counter-light-entering surface is shorter. With such a configuration, even if the intensity of the light irradiated from the light emitting elements 101 corresponding to the area where the distance from the light-entering surface to the counter-light-entering surface is longer is made higher than the intensity of the light irradiated from the light emitting elements 101 corresponding to the area where the distance from the light-entering surface to the counter-light-entering surface is shorter, there is still a possibility that the brightness of the display panel PNL will not be uniform.

However, according to the configuration shown in FIG. 11, even if the light irradiated from the light emitting element 101a corresponding to the area where the distance from the light-entering surface to the counter-light-entering surface is shorter, progresses towards the area where the distance from the light-entering surface to the counter-light-entering surface is longer after entering the second cover member CM21, the light is totally reflected by a side surface CM21a of the second cover member CM21 (more specifically, by the interface between the side surface CM21a and the air layer). In other words, it is possible to suppress the light emitted from the light emitting element 101a corresponding to the area where the distance from the light-entering surface to the counter-light-entering surface is shorter, from progressing (leaking out) towards the area where the distance from the light-entering surface to the counter-light-entering surface is longer.

Similarly, according to the configuration shown in FIG. 11, even if the light irradiated from the light emitting element 101b corresponding to the area where the distance from the light-entering surface to the counter-light-entering surface is longer, progresses towards the area where the distance from the light-entering surface to the counter-light-entering surface is shorter after entering the second cover member CM22, the light is totally reflected by a side surface CM22a of the second cover member CM22 (more specifically, by the interface between the side surface CM22a and the air layer). In other words, it is possible to suppress the light emitted from the light emitting element 101b corresponding to the area where the distance from the light-entering surface to the counter-light-entering surface is longer, from progressing (leaking out) towards the area where the distance from the light-entering surface to the counter-light-entering surface is shorter.

Note that a similar effect can also be obtained for the light emitted from the light emitting module 100a disposed to oppose the side surface of the first cover member CM1.

According to the configuration, the linear progression properties of the light irradiated from each light emitting element 101 contained in the light emitting modules 100a and 100b can be improved, and therefore it is possible to make the brightness of the display panel PNL uniform.

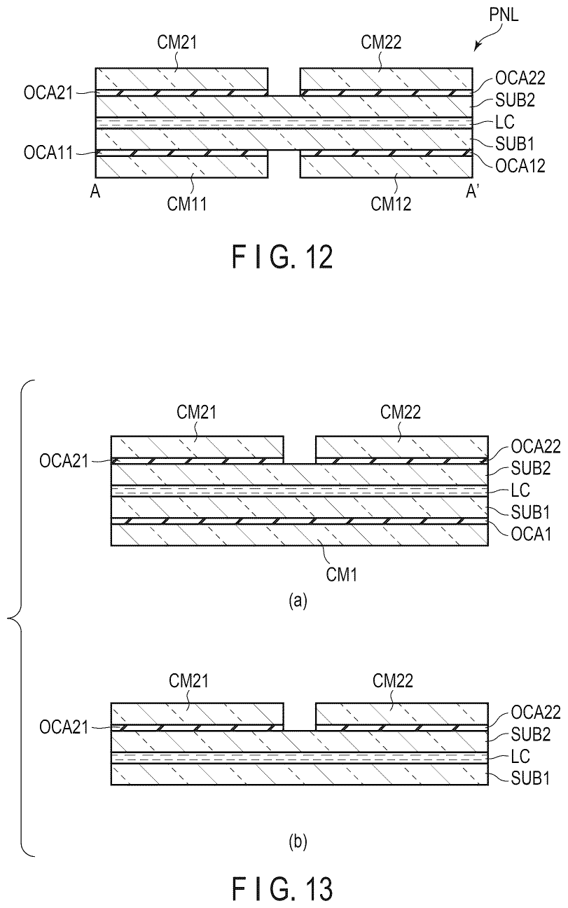

FIG. 12 is a cross-sectional view showing an example of the display panel PNL taken along the line A-A′ in FIG. 11. As shown in FIG. 12, the display panel PNL of the first modified example comprises a first substrate SUB1, a second substrate SUB2, a liquid crystal layer LC disposed between the first substrate SUB1 and the second substrate SUB2, first cover members CM11 and CM12, and second cover members CM21 and CM22.

The first cover member CM11 is a cover member adhered to underneath the first substrate SUB1 via an adhesive layer OCA11, which corresponds to the area where the distance from the light-entering surface to the counter-light-entering surface is shorter. The first cover member CM12 is a cover member adhered to underneath the first substrate SUB1 via an adhesive layer OCA12, which corresponds to the area where the distance from the light-entering surface to the counter-light-entering surface is longer.

The second cover member CM21 is a cover member adhered to underneath the second substrate SUB2 via an adhesive layer OCA21, which corresponds to the area where the distance from the light-entering surface to the counter-light-entering surface is shorter. The second cover member CM22 is a cover member adhered to underneath the second substrate SUB2 via an adhesive layer OCA22, which corresponds to the area where the distance from the light-entering surface to the counter-light-entering surface is longer.

Note that the display panel PNL of the first modified example may as well be configured as shown in FIG. 13, part (a), in which only the second cover member CM2 is divided into a plurality of parts, and the first cover member CM1 is not divided into parts.

Further, the display panel PNL of the first modified example may as well be configured as shown in FIG. 13, part (b), in which the second cover member CM2 is divided into a plurality of parts without providing the first cover member CM1. In this case, the light emitting module 100a opposing the side surface of the first cover member CM1 may not be disposed, or it may be disposed to oppose the side surface of the first transparent substrate 10 included in the first substrate SUB1.

According to the configurations shown in FIG. 13, part (a) and part (b), part of the light emitted from the light emitting element 101 included in the light emitting module 100a, which corresponds to the area where the distance from the light-entering surface to the counter-light-entering surface is shorter, progresses toward the area where the distance from the light-entering surface to the counter-light-entering surface is longer, and part of the light emitted from the light emitting element 101 corresponding to the area where the distance from the light-entering surface to the counter-light-entering surface is longer progresses toward the area where the distance from the light-entering surface to the counter-light-entering surface is shorter. However, the light diffracts from one area (part) to the other or vice versa, and therefore it is possible to make the boundary (groove) between the second cover members CM21 and CM22 less noticeable (less visible).

### Second Modified Example

Next, the second modified example will be explained. A display device DSP2 of the second modified example is different in configuration of the above-provided embodiment in that the shapes and sizes of the first substrate SUB1 and the second substrate SUB2 are different from the shapes and sizes of the first cover member CM1 and the second cover member CM2, respectively.

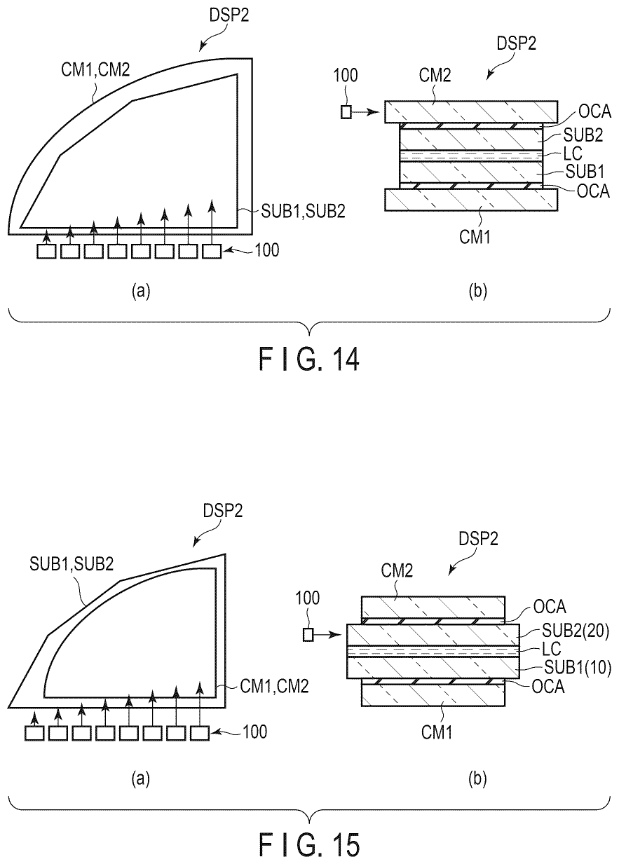

One factor of the reasons why the shapes and sizes the first substrate SUB1 and the second substrate SUB2 are different from the shapes and sizes of the first cover member CM1 and the second cover member CM2 is that the liquid crystal layer LC is disposed between the first substrate SUB1 and the second substrate SUB2 and therefore it is difficult to form a curved portion (curved surface), as shown in FIG. 14 or FIG. 15, which will be described later, but it is easy to form a curved portion in the first cover member CM1 and the second cover member CM2.

FIG. 14 is a diagram showing an example of the display device DSP2 according to the second modified example. FIG. 14, part (a) is a plan view showing an example of the display device DSP2 in which the shapes and sizes of the first cover member CM1 and the second cover member CM2 are larger than the shapes and sizes of the first substrate SUB1 and the second substrate SUB2, and FIG. 14, part (b), is a cross-sectional view showing an example of the display device DSP2. Although not illustrated in FIG. 14, the outermost circumferences of the first cover member CM1 and the second cover member CM2 are covered by the housing or frame.

In this case, it is preferable that the light emitting module 100 should be disposed so as to oppose a respective side surface of the second cover member CM2, which is larger in shape than the first substrate SUB1 and the second substrate SUB2, as shown in FIG. 14, part (b). Note that such a configuration is shown here that the light emitting module 100 is arranged to oppose the side surface of the second cover member CM2, but the light emitting module 100 may as well be arranged to oppose a respective side surface of the first cover member CM1, which is larger in shape than the first substrate SUB1 and the second substrate SUB2. Alternatively, two light emitting modules 100 may as well be arranged so as to oppose the side surfaces of the first cover member CM1 and the second cover member CM2, respectively.

FIG. 15 is a diagram showing an example of a display device DSP2 according to the second modified example. FIG. 15, part (a) is a plan view showing an example of the display device DSP2, in which the shapes and sizes of the first substrate SUB1 and the second substrate SUB2 are larger than the shapes and sizes of the first cover member CM1 and the second cover member CM2, and FIG. 15, part (b) is a cross-sectional view showing an example of the display device DSP2. Although not shown in FIG. 15, the outermost circumferences of the first substrate SUB1 and the second substrate SUB2 are covered by a housing or frame.

In this case, it is preferable that the light emitting module 100 should be arranged so as to oppose a respective side surface of the second transparent substrate 20 of the second substrate SUB2, which is larger in shape than the first cover member CM1 and the second cover member CM2, as shown in FIG. 15, part (b). Note that such a configuration is shown here that the light emitting module 100 is arranged so as to oppose the side surface of the second transparent substrate 20 of the second substrate SUB2, but the light emitting module 100 may as well be arranged so as to oppose the side surface of the first transparent substrate 10 of the first substrate SUB1, which is larger in shape than the first cover member CM1 and the second cover member CM2. Alternatively, two light emitting modules 100 may as well be disposed so as to oppose the side surfaces of the first transparent substrate 10 and the second transparent substrate 20, respectively.

According to the above-described embodiment, it is possible to provide display devices DSP, DSP1, and DSP2 having irregular shapes, which can make the brightness of the display panel PNL uniform.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a first substrate including a first main surface of a shape different from a rectangle;
a second substrate including a second main surface of a shape different from a rectangle and opposing the first substrate;
a polymer-dispersed liquid crystal layer disposed between the first substrate and the second substrate;
a cover member including a first side surface and a third main surface of a shape different from a rectangle and opposing the second substrate;
a plurality of light emitting elements which irradiate light on the first side surface; and
an adjustment unit which adjusts intensity of the light irradiated from each of the light emitting elements,
wherein
the first side surface includes a light-entering surface, which is an area into which the light irradiated from each of the light emitting elements enters, and
the adjustment unit adjusts the intensity of the light irradiated from each of the light emitting elements in accordance with a distance from the light-entering surface to a counter-light-entering surface located on an opposite side to the light-entering surface.

2. The display device of claim 1, wherein
the adjustment unit increases the intensity of light emitted from those of the light emitting elements which correspond to an area where the distance from the light-entering surface to the counter-light-entering surface is longer, to be higher than the intensity of light emitted from those of the light emitting elements which correspond to an area where the distance from the light-entering surface to the counter-light-entering surface is shorter.

3. The display device of claim 2, wherein
the adjustment unit adjusts the intensity of light irradiated from each of the light-emitting elements by making a time for which current is allowed to flow through each of the light-emitting elements constant and making current allowed to flow through those of the light emitting elements which correspond to an area where the distance from the light-entering surface to the counter-light-entering surface is longer, to be larger than current allowed to flow through those of the light-emitting elements which correspond to an area where the distance from the light-entering surface to the counter-light-entering surface is shorter.

4. The display device of claim 2, wherein
the adjustment unit adjusts the intensity of the light irradiated from each of the light emitting elements by making current allowed to flow through each of the light emitting elements constant and making a time for which current is allowed to flow through those of the light emitting elements which correspond to an area where the distance from the light-entering surface to the counter-light-entering surface is longer, to be longer than a time for which current is allowed to flow through those of the light emitting elements which correspond to an area where the distance from the light-entering surface to the counter-light-entering surface is shorter.

5. The display device of claim 2, wherein
the adjustment unit adjusts the intensity of the light irradiated from each of the light emitting elements by making current allowed to flow through each of the light emitting elements constant, and making a time for which those of the light emitting elements which correspond to an area where the distance from the light-entering surface to the counter-light-entering surface is longer is on, to be longer than a time for which those of the light emitting elements which correspond to an area where the distance from the light-entering surface to the counter-light-entering surface is shorter is on.

6. The display device of claim 2, wherein
the adjustment unit turns on light emitting elements more densely in an area where the distance from the light-entering surface to the counter-light-entering surface is longer, than in an area where the distance from the light-entering surface to the counter-light-entering surface is shorter.

7. The display device of claim 1, wherein
the light emitting elements are disposed more densely in an area where the distance from the light-entering surface to the counter-light-entering surface is longer, than in an area where the distance from the light-entering surface to the counter-light-entering surface is shorter, and
the adjustment unit adjusts the intensity of the light irradiated from each of the light emitting elements to be equal.

8. The display device of claim 1, wherein
in an area where the distance from the light-entering surface to the counter-light-entering surface is longer, auxiliary light-emitting elements are provided on a counter-light-entering surface side.

9. The display device of claim 1, wherein
the adjustment unit increases the intensity of light emitted from those of the light emitting elements which correspond to an area where an image is displayed, to be higher than the intensity of light emitted from those of the light emitting elements which correspond to an area where no image is displayed.

10. The display device of claim 1, wherein
the second main surface includes a first area having a first length along a direction perpendicular to the light-entering surface and a second area having a second length along the direction perpendicular to the light-entering surface,
the first length is less than the second length,
the cover member includes a third area overlapping the first area and a fourth area opposing the second area in plan view, and
the third area is separated apart from the fourth area.

11. The display device of claim 1, further comprising:
a lens disposed between the plurality of light-emitting elements and the first side surface.

12. The display device of claim 1, wherein
the first side surface is processed into a lens-like shape.

13. The display device of claim 1, wherein
a shape of the first main surface, a shape of the second main surface, and a shape of the third main surface are identical to each other.

14. The display device of claim 1, wherein
a shape of the first main surface is different from a shape of the third main surface.

15. The display device of claim 1, wherein
a shape of the second main surface is different from a shape of the third main surface.

16. The display device of claim 15, wherein
the shape of the first main surface, the shape of the second main surface, and the shape of the third main surface are different from each other.

17. The display device of claim 1, further comprising:
a second cover member,
wherein
the first substrate is located between the second substrate and the second cover member, and
the second substrate is located between the first substrate and the cover member.

18. A display device comprising:
a first substrate;
a second substrate opposing the first substrate;
a liquid crystal layer disposed between the first substrate and the second substrate;
a cover member disposed at an opposite side of the second substrate from the first substrate; and
a first light emitting element and a second light emitting element disposed to oppose to a side surface of the cover member and having a variable intensity of light emitted,
wherein
the side surface includes a first portion and a second portion,
the first portion has a distance closest to the first light emitting element in the side surface,
the second part has a distance closest to the second light emitting element in the side surface, and
the cover member has a first length, which is a length from the first portion, along a direction perpendicular to the side surface and a second length, which is a length from the second portion, along the same direction,
the first length is different from the second length, and
a first light intensity of the first light emitting element is different from a second light intensity of the second light emitting element.

19. The display device of claim 18, further comprising:
a plurality of light emitting elements including the first light emitting element and the second light emitting element, and
a controller which controls light intensity of each of the plurality of light emitting elements,
wherein
the plurality of light emitting elements are driven in a field sequential mode.

20. The display device of claim 18, wherein
the first length is greater than the second length, and
the first light intensity is higher than the second light intensity.
